(19) United States
(12) Patent Application Publication
(10) Pub. No.: US 2002/0112106 A1
(43) Pub. Date: Aug. 15, 2002

(54) Backplane physical layer controller with an internal bus reset

(76) Inventors: Burke S. Henehan, Dallas, TX (US); Michael G. Ho-Lung, Dallas, TX (US)

Correspondence Address: J. Dennis Moore, Texas Instruments Incorporated, PO Box 655474, M/S 3999, Dallas, TX, 75265, US

(21) Appl. No.: 09/737,922

(22) Filed: Dec. 15, 2000

(51) Int. Cl. G06F 13/36

(52) U.S. Cl. 710/113; 710/107

(57) ABSTRACT

A physical layer (PHY) controller (314) for arbitrating and resetting a bus for devices coupled to a tri-stateable transceiver (316). The controller (314) includes a tri-stateable driver output enable pin (TDOE) and a novel arbitration scheme. A particular priority code and node address are used in the arbitration number used to arbitrate for the bus before resetting the bus.

### CROSS-REFERENCE TO RELATED APPLICATIONS

This invention is related to commonly-assigned patent application Ser. No. 09/666,023 entitled “Backplane Physical Layer Controller” by Burke Henehan filed on Sep. 19, 2000, docket number TI-30316. This application is incorporated herein by reference in its entirety.

### FIELD OF THE INVENTION

This invention relates generally to semiconductor devices and systems, and more specifically to backplane physical layer controllers.

### BACKGROUND OF THE INVENTION

Electronic systems generally include a number of components that perform various functions. These components must be interconnected either by connecting individual components together and/or by connecting groups of components to a bus. An example of such an interconnection is a motherboard having a bus that interconnects several daughtercards sharing the bus.

Numerous varieties of buses can be used in systems utilizing a bus to connect components. For example, a parallel bus would include more than one data line so that multiple bits of data can be transferred simultaneously. In a serial bus, a single data line is used to carry data between devices sometimes in conjunction with a line to carry the clock signal. With most buses, a means of arbitrating the bus between the various components or daughtercards is needed, which arbitration is typically provided in a single integrated circuit.

One type of back-plane serial bus is specified by IEEE-Std-1394-1995. See IEEE Standard for a High Performance Serial Bus, Institute of Electrical and Electronics Engineers, Aug. 30, 1996. This standard describes a high-speed, low-cost back-plane serial bus suitable for use as a peripheral bus or as a secondary control backup to parallel back-plane buses. This standard is hereby incorporated herein by reference.

1394 provides an interface solution for a wide variety of networking applications, providing a means of transmitting data without burdening the host unit. An integrated circuit adapted to meet the requirements of chapter 5 of the 1394 standard includes a 1394 backplane physical layer controller 14 available from Texas Instruments Incorporated as part number TSB14C01A, which is described by the data sheet entitled “TSB14C01A, TSB1401AI, TSB14C01AM 5-V IEEE 1394-1995 Backplane Transceiver/Arbiter”, Texas Instruments Incorporated, 1999, pp. 1-30, which is incorporated herein by reference.

FIG. 1 shows a system block diagram for a single node on a backplane bus system 10. As shown in the figure, 1394 link layer controller 12 (link) is coupled to a host interface and provides digital data to a 1394 backplane physical layer controller 14 (PHY). The 1394 backplane physical layer controller 14 provides the signaling for the 1394-compliant bus to transceiver 16. The transceiver 16 is coupled to the bus (not shown).

A shortcoming of the IEEE 1394-1995 specification is that it only defines open collector transceivers be used with the backplane physical layer (PHY) arbitration defined in the specification. However, users of backplane PHY controllers have implemented systems with tri-stateable drivers based on using the CTL[0, 1], N_OEB_D, TSRTB, and TDATA output signals from the TI TSB 14C01 to decode particular times to enable the strobe and data transmitter portions of the tri-stateable transceivers to be used. This has enabled tri-stateable transceivers to be used with the TSB14C01 backplane PHY with the use of external high speed programmable logic between the TSB14C01 and the selected tri-stateable transceivers.

### SUMMARY OF THE INVENTION

In one aspect, the present invention provides an implementation of a new 1394 backplane PHY controller that implements logic internal to the PHY controller that enables use of tri-stateable transceivers without the possibility of contention during arbitration or during a 1394 bus reset.

In one aspect, the present invention discloses a method of resetting a physical layer bus that has a number of devices coupled to it. The method includes arbitrating for the bus using a particular priority code and a particular address. Upon winning the bus, a bus reset condition is driven onto the bus. In the preferred embodiment, the particular address “111111” and a priority code of “1111” are provided to the backplane physical layer controller.

The present invention also contemplates a method of arbitrating for the physical layer bus. In this embodiment, the method includes controlling when the data line of the data and strobe transceiver pair are enabled when arbitrating for the bus.

Further disclosed is a serial bus backplane physical layer controller that includes digital interface circuitry. Serial bus interface circuitry is coupled to receive data from the digital interface circuitry. The digital interface circuitry and the serial bus interface circuitry are configured to be compatible with a serial bus physical layer controller that complies with IEEE-Std-1394-1995. The controller includes register decode circuitry including a plurality of address bit inputs, the decode circuitry adapted to receive six-bit address data, and priority decode circuitry adapted to receive four-bit address data. The controller also includes a means of resetting the serial bus backplane physical layer controller.

Also disclosed is a system that includes a serial bus, at least a portion of which is formed on a circuit board. A physical layer controller is coupled to the serial bus. In this embodiment, the physical layer controller includes register decode circuitry, including a plurality of address bit inputs and being adapted to receive six-bit address data. The controller also includes priority decode circuitry adapted to receive four-bit data, and a means of resetting the serial bus backplane physical layer controller. The system includes a link layer controller coupled to the physical layer controller, and a processor coupled to the link layer controller.

Advantages of the present invention include providing an internal bus resetting function to a backplane PHY controller. The bus may be reset while using tri-stateable transceivers without conflicting with other nodes or devices coupled to the bus. Furthermore, an additional pin is provided to the controller to provide the data transceiver control function of the present invention, allowing tri-stateable transceivers to be arbitrated without the use of an external logic circuit.

### BRIEF DESCRIPTION OF THE DRAWINGS

The above features of the present invention will be more clearly understood from consideration of the following descriptions in connection with accompanying drawings in which:

FIG. 1 is a block diagram of a prior art 1394 link layer and 1394 backplane physical layer;

FIG. 2a is a block diagram of a prior art open collector transceiver in use with a backplane PHY controller;

FIG. 2b shows one of the buffers of the transceiver of FIG. 2a;

FIG. 3 shows a block diagram of a prior art tri-stateable transceiver in use with a backplane PHY controller;

FIG. 4a is a block diagram of a preferred embodiment backplane PHY;

FIG. 4b shows the backplane physical layer controller of the present invention implementing a tri-stateable transceiver; and

FIG. 5 is a bock diagram of a system that can utilize the controller of the present invention.

### DETAILED DESCRIPTION OF ILLUSTRATIVE EMBODIMENTS

A problem with two configurations of prior art 1394 arbitrators will be discussed, followed by a description of the present invention generally and then in the context of a specific example.

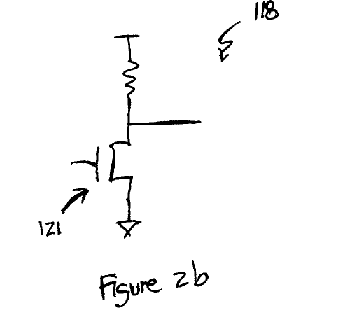

A prior art configuration of a backplane physical layer controller 114 used with an open collector transceiver 116 is shown in FIG. 2a. This is the typical configuration for the use of a controller 114. Controller 114 may comprise a TSB14C01, for example. Each inverting buffer 118 preferably comprises a transistor in an open collector configuration, an example of which is shown in FIG. 2b. The open collector transceiver 116 has two states. In a first state, the transistor 121 is off (non-conductive) and therefore the output is pulled high. This is the inactive state of the system. In the other state, the transistor is turned on so that the output is pulled to ground. When nodes coupled to the transceiver 116 ask for the bus, they do so by pulling it down.

According to the 1394 specification, any device of a bus can reset the bus at any time. The prior art implementation of a bus reset depends on the wired-OR of open collector transceiver 116 to avoid bus contention. In the prior art configuration shown in FIG. 2a, a bus reset indication (“11”) is asserted on the bus lines regardless of whether a transaction is currently taking place on the bus, e.g. with another device, or not. Since the wired-OR logic transceiver 116 is inverting, it only drives the bus to assert an input high state and releases it to signal an input low state. This means that the node signaling reset simply overrides any other node on the bus without contention. On a tri-state bus, however, the transceiver 116 drives the bus to both high and low states, and bus contention, transceiver damage, and overriding of other nodes on the bus may occur with this configuration.

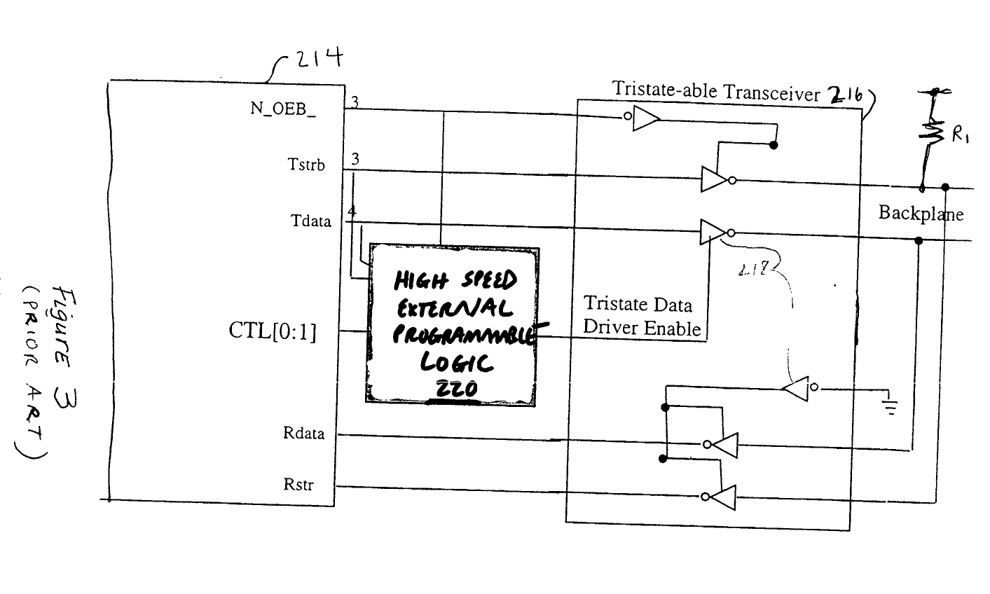

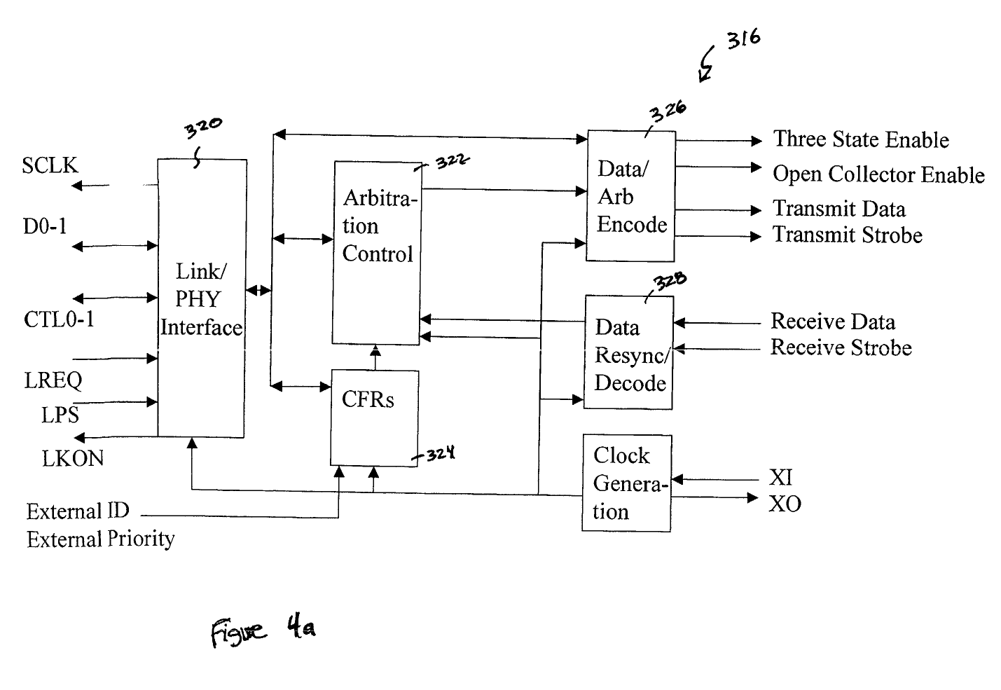

FIG. 3 shows a prior art block diagram of a backplane physical layer controller 114 used with a tri-stateable transceiver 216. An external high speed programmable logic circuit 220 is required for controlling the reset function of the bus to avoid contention of the bus reset and prevent overriding nodes on the bus without contention. This is disadvantageous in that another integrated circuit 220 is required in the system. A challenge with a tri-stateable transceiver 216 is to avoid one node pulling the bus up while, at the same time, another node is pulling the bus down, as could occur during arbitration or when bus reset is signaled.

In one aspect the present invention provides a 1394 backplane PHY controller that implements logic internal to the PHY controller to enable the use of tri-stateable transceivers without the possibility of contention during a bus reset.

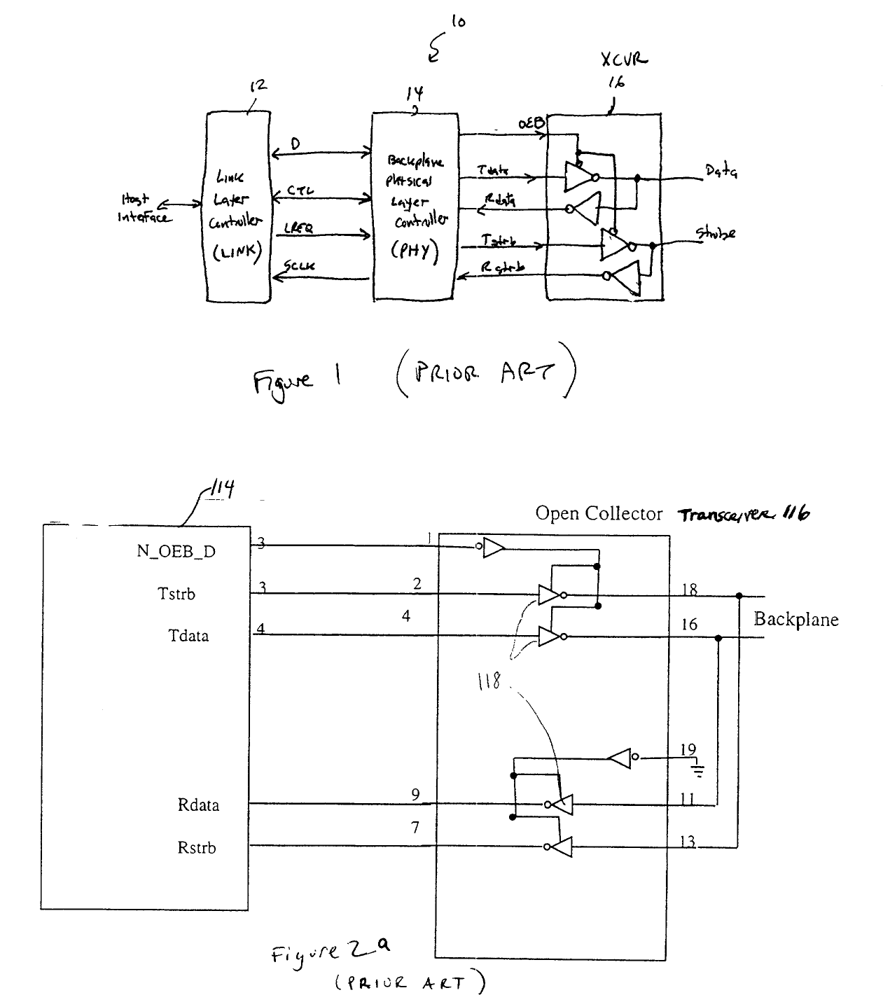

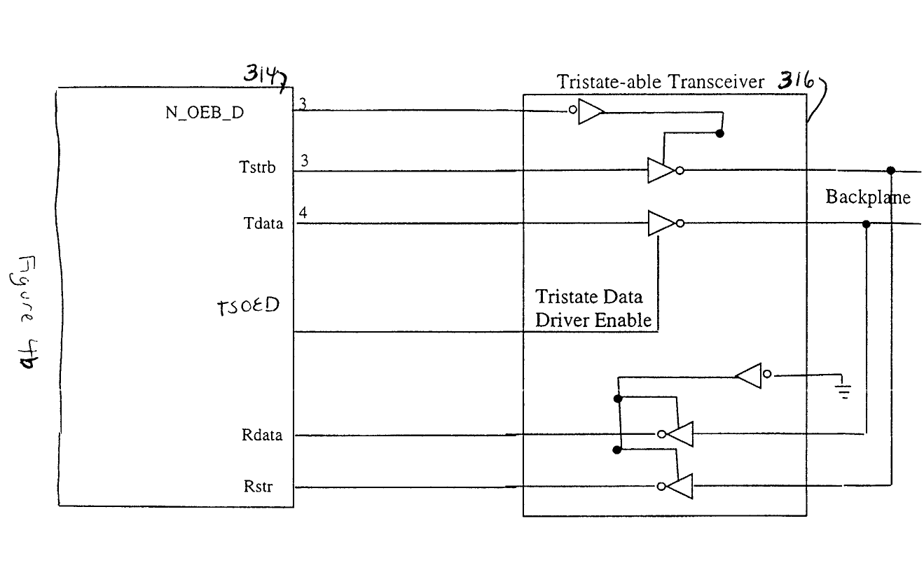

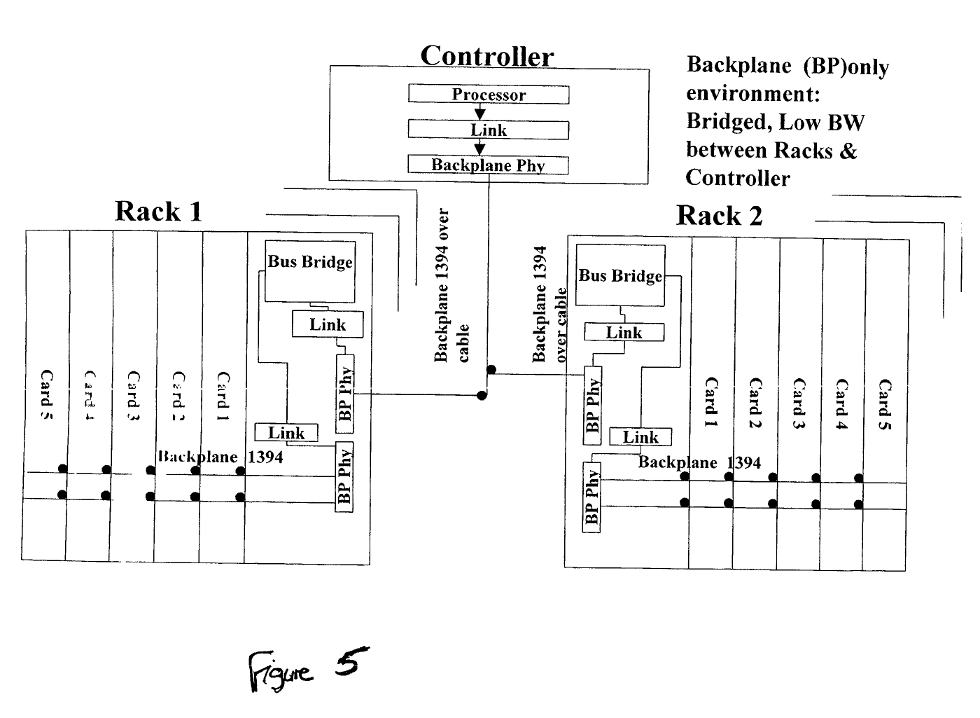

FIG. 4a shows a block diagram of a backplane physical layer controller (PHY) 316. Backplane PHY 316 includes digital interface circuitry 320 for interfacing with the link layer controller (see FIG. 1). The digital interface circuitry 322 and configuration status registers (CFRs) 324. The arbitration control circuitry can execute an algorithm to determine which device coupled to the serial bus (not shown) will have access to the bus. Further discussion of a preferred embodiment algorithm is presented below.

Backplane PHY 316 also includes interface circuitry to be coupled to a transceiver (see FIG. 1). For example, data/arbitration and encode circuitry 316 provides output signals labeled Three State Enable, Open Collector Enable, Transmit Data and Transmit Strobe. The two transmit signals, along with the enable signals, define the state of the bus. The transmit signals are utilized in a manner similar to the prior art.

Data synchronization and decode circuitry 326 includes input nodes labeled Receive Data and Receive Strobe. The nodes receive signals in the same manner as prior art 1394 devices.

One novel function of the preferred embodiment of the present invention is that the node will arbitrate for the bus before asserting the bus reset signal. In order to function properly and gain the bus without causing disruption, the arbitration must be performed as a priority request. To use immediate or isochronous arbitration runs the risk of contending with an acknowledge packet. To use fair or urgent arbitration means the reset could be delayed excessively.

Another novel function of the preferred embodiment of the present invention is that in order to win the bus as soon as possible, the node issuing the bus reset should preferably arbitrate with a particular priority code and address. Preferably, these are selected so that the device will access the bus quickly. In the preferred embodiment, the bus reset is indicated using both a priority number of all ones and a node number of all ones. This is an illegal node number for a node to use to as its own node number, but is not illegal for a node to use to transmit.

FIG. 4b illustrates a block diagram of the present backplane PHY controller 314 in accordance with the present invention, coupled to a tri-stateable transceiver 316. Controller 314 comprises a pin labeled tri-stateable driver output enable (TDOE).

In the preferred embodiment, the physical layer controller includes a register that stores, amongst other things, a six bit physical identifier (address) and a four bit priority level. The priority level defines the importance of a particular packet. In the 1394 controller of the preferred embodiment, the physical ID will be located at bits 0-5 of the register at address 0000 and the priority level will be located at bits 0-3 of the register at address 0100. Co-pending application Ser. No. 09/666,023 provides further details about the register set of a backplane PHY of the preferred embodiment and is incorporated herein by reference.

During arbitration each node that is arbitrating for the bus drives its priority code and its node number out onto the bus. During each bit period each node reads back what has been placed on the bus. If a node reads back the same data it was sending, it stays in contention for winning the bus. If the node reads something different than what it was driving, it loses the bus and drops out of contention. This is the reason for requiring open collector operation during arbitration, in the prior art configuration shown in FIG. 2, it allows some nodes to be transmitting one while other nodes are transmitting zero with no driver conflict. As long as each node is still sending zeros (not driving any value on the bus) during arbitration, all nodes are still contending to win the bus. The node with the highest priority (or in case of a tie, the highest node number) will be the first to drive a one onto the bus (assert a state onto the bus) during arbitration. The node that sends the first one (asserted the bus) will read it back and still be in contention for winning the bus. All the other nodes will read back a one which will not match the zero (released bus) they were sending and they will drop out of contention.

For example, Table 1 shows three nodes each with four bit of “0000” priority and six bit node IDs of 8 (001000), 7 (000111)and 2 (000010) arbitrating for the bus by driving their arbitration numbers onto the bus. Note that this bus is reverse logic, a logic 1 being driven by a TSB14C01 is asserted by driving the GND state on the bus by the transceiver. Conversely a logic 0 being driven by a TSB 14C01 is asserted by the transceiver releasing the bus to return to approximately Vcc the pullup HIGH rail.

TABLE 1

| | Priority | | | | Physical ID | | | | | |
|---|---|---|---|---|---|---|---|---|---|---|
| Time Slot | 1 | 2 | 3 | 4 | 5 | 6 | 7 | 8 | 9 | 10 |
| Driven by Node #2 | 0 | 0 | 0 | 0 | 0 | 0 | 0 | Z | Z | Z |
| Driven by Node #7 | 0 | 0 | 0 | 0 | 0 | 0 | 0 | Z | Z | Z |
| Driven by Node #8 | 0 | 0 | 0 | 0 | 0 | 0 | 1 | 0 | 0 | 0 |
| Electrical Voltage Level on Bus | Vcc | Vcc | Vcc | Vcc | Vcc | Vcc | gnd | Vcc | Vcc | Vcc |

Since the highest node number is 8 (1000b), that node will be the first to assert the bus (by outputting a one ) and will win the arbitration. The other nodes that lost the arbitration drop out after the reading the logical “1” in time slot 7 when they were sending a logical “0”. The nodes that lost, release the bus by only driving zeros for the remainder of arbitration to the transceiver which is inverted to VCC on the bus.

Table 2 illustrates an example of a robust bus reset of the present invention. In this example, the device at node 7 is going to assert the reset. Devices at nodes 2 (000010b), 56 (111000b) and 62 (111110b) are also arbitrating for the bus. Since a physical ID of all one's (e.g., a node 63) is not legal, the node 62 example provides the worst case contention for the bus.

TABLE 2

| | Priority | | | | Physical ID | | | | | |
|---|---|---|---|---|---|---|---|---|---|---|
| Time Slot | 1 | 2 | 3 | 4 | 5 | 6 | 7 | 8 | 9 | 10 |
| Driven by Node #2 | 0 | Z | Z | Z | Z | Z | Z | Z | Z | Z |
| Driven by Node #7 | 1 | 1 | 1 | 1 | 1 | 1 | 1 | 1 | 1 | 1 |
| Driven by Node #56 | 1 | 1 | 1 | 1 | 1 | 1 | 1 | Z | Z | Z |
| Driven by Node #62 | 1 | 1 | 1 | 1 | 1 | 1 | 1 | 1 | 1 | Z |

As shown in Table 2, in the first time slot each device other than the one at node 2 asserts the bus. In other words, the device at node 2 asserts a “0” while the other devices assert a logical “1.” In the open collector scheme, this will not create a contention. In tri-state mode, the bus could end up in an undefined state if one device drives to a logical “0” while another device drives to a logical “1.”

Shortly after the device at node 2 asserts a “0” at time slot 1, it will determine that it does not get the bus. At that point, this device will not attempt to take the bus. In the example provided, each of the other devices will continue to drive “1”'s onto the bus until it is determined that they have lost contention. Since the device at node 7 has used what must (in the case of a 1394 compliant system) be the highest priority and node number, this node will win and can then drive the bus reset indication on the bus.

In another aspect, the present invention provides a 1394 backplane PHY controller that implements logic internal to the PHY controller to enable the use of tri-stateable transceivers without the possibility of contention during a bus reset.

For example, Table 3 shows the same three nodes used in Table 1, each with four bit of “0000” priority and six bit node IDs of 8 (001000), 7 (000111)and 2 (000010) arbitrating for the bus. Note that this bus is reverse logic, a logic 1 being driven by a TSB14C01 is asserted by driving the GND state on the bus by the transceiver. Conversely, a logic 0 being driven by a TSB14C01 is asserted by the transceiver driving the bus to the Vcc HIGH rail. A “Z” or high impedance is presented to the bus when the transceiver is disabled by controlling it with it enable line. For this reason the TDOE pin was added to the implementation. When a zero would normally be driven out on the bus, the TDOE signal disables the output so that it presents a high impedance to the bus. In this bus implementation when no signal is being driven on the bus it will go to the Vcc state.

TABLE 3

| | Priority | | | | Physical ID | | | | | |
|---|---|---|---|---|---|---|---|---|---|---|
| Time Slot | 1 | 2 | 3 | 4 | 5 | 6 | 7 | 8 | 9 | 10 |
| Driven by Node #2 | Z | Z | Z | Z | Z | Z | Z | Z | Z | Z |
| Driven by Node #7 | Z | Z | Z | Z | Z | Z | Z | Z | Z | Z |
| Driven by Node #8 | Z | Z | Z | Z | Z | Z | 1 | Z | Z | Z |
| Electrical Voltage Level on Bus | Vcc | Vcc | Vcc | Vcc | Vcc | Vcc | gnd | Vcc | Vcc | Vcc |

Since the highest node number is 8 (1000b) that node will output the first one (assert) the bus and win the arbitration. The other nodes that lost the arbitration drop out after the reading the logical “1” in time slot 7 when they were sending a logical “0” (by presenting a high impedance). The nodes that lost, release the bus by leaving their transceiver in the high impedance mode for the remainder of arbitration which allows the nodes still in contention to drive the bus.

The present invention can be used in a variety of contexts. As an example, FIG. 5 presents a block diagram for a typical control bus application. In this figure, each card in each rack has a controller attached to a 1394 link layer that is attached to a 1394 backplane PHY controller, which is in turn attached to a tri-stateable transceiver, which finally is attached to the etches (e.g., conductive traces) that are the 1394 bus. In this system, the primary data flow is across another “big pipe” parallel bus. The data that flows across the 1394 serial bus is low volume control or test traffic. Since this is a separate bus from the “big pipe” it can be used to monitor and control the flow of data through the “big pipe” increasing reliability and easing diagnostics when a “big pipe” component breaks.

The present invention is also applicable in applications where the bus resides within a standard parallel backplane. Examples of such standard parallel backplanes include VME, Compact PCI, FutureBus+, and others.

It is noted that the present invention is not limited to physical layer controllers. Other devices that have the same types of decoding and compatibility issues could also utilize the inventive concepts of the present invention.

The PHY controller 316 of the present invention may be used in a variety of systems. One such example is in a wireless base station where the 1394 bus is used to supplement a parallel bus. For example, this bus can be used for initial test and as a backup bus.

Advantages of the present invention include providing an internal bus resetting function to a backplane PHY controller. The bus may be reset without a transceiver conflict with any other node transceiver coupled to the bus. Furthermore, an additional pin is provided to the controller 316 to provide the control over the data transceiver during the arbitration phase function of the present invention. These allow tri-stateable transceivers to be arbitrated and to initiate bus resets without the use of an external logic circuit 220.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. For example, the bus can be arbitrated asynchronously or isochronously, depending upon the application. In addition, the order of process steps may be rearranged by one of ordinary skill in the art, yet still be within the scope of the present invention. It is therefore intended that the appended claims encompass any such modifications or embodiments. Moreover, the scope of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. A method of operating a bus controller to drive a bus reset indication for a bus in a system, the method comprising:
arbitrating for the bus using an arbitration access method, the arbitration access method using a priority code that is the highest priority code used in the system and a node address that is higher than a highest node address of any device coupled to the bus; and
substantially after arbitration has been completed, driving a bus reset indication on the bus.

2. The method of claim 1 wherein the priority code comprises a priority code of all ones.

3. The method of claim 2 wherein the node address comprises a node address of all ones.

4. The method of claim 1 wherein the node address comprises a node address of all ones.

5. The method of claim 1 wherein the bus comprises a bus that complies with the IEEE-1394 standard.

6. The method of claim 5 wherein the priority code comprises “1111” and the address node comprises “111111.”

7. The method of claim 1 wherein the bus resides within a standard parallel backplane.

8. The method of claim 1 wherein the bus resides within a wireless base station.

9. The method of claim 1 wherein the arbitrating occurs before asserting a bus reset indication on the bus.

10. The method of claim 1 wherein the method comprises operating a backplane physical layer controller.

11. A method of operating a 1394 backplane PHY to drive a bus reset indication for a bus, the method comprising:
arbitrating for the bus using a priority arbitration access method to the bus, the priority arbitration access method using an arbitration number with the priority field of all ones and using an arbitration number with the node address field of all ones; and
substantially after arbitration has been completed and won, driving the bus reset indication on the 1394 bus.

12. The method of claim 11 wherein the arbitrating occurs after receiving a bus reset request from a 1394 link layer.

13. The method of claim 12 wherein the arbitrating occurs before asserting a bus reset indication on the bus.

14. The method of claim 11 wherein the backplane PHY includes a tri-stateable driver output enable (TDOE), the method further comprising only enabling the output of the backplane PHY when driving a logical “one (1)” during the arbitration such that the output is put into a high impedance state when driving a logical “zero (0)” during arbitration.

15. A method of requesting a bus reset for a bus that complies with IEEE-1394, the method comprising:
initiating an arbitration for the bus, the arbitration using a highest priority code and a node address of all logical ones.

16. The method of claim 15 wherein the highest priority code comprises all ones.

17. The method of claim 15 wherein the initiating is performed by a backplane physical layer controller.

18. The method of claim 17 wherein the backplane physical layer controller includes a tri- stateable driver output enable (TDOE), the method further comprising only enabling the output of the backplane PHY when driving a logical “one (1)” during the arbitration such that the output is put into a high impedance state when driving a logical “zero (0)” during arbitration.

19. A method of arbitrating for a backplane 1394 bus, the method comprising:
generating a priority code at a serial output of a backplane physical layer controller; and
generating an address node at the serial output of the backplane physical layer controller;
wherein the backplane physical layer controller includes a tri-stateable driver output enable, the tri-stateable output enable being at a first logic level when a “1” is generated at the serial output and being at a second logic level when a “0” is generated at the serial output.

20. The method of claim 19 wherein the serial output of the backplane physical layer controller is driven onto the 1394 bus only when the tri-stateable output enable is at the first logic level.

21. The method of claim 20 wherein the backplane physical layer controller is coupled to a transceiver and wherein the transceiver is disabled when the tri-stateable output enable is at the second logic level.

22. A serial bus backplane physical layer controller comprising:
digital interface circuitry;
serial bus interface circuitry coupled to receive data from the digital interface circuitry, the digital interface circuitry and the serial bus interface circuitry configured to be compatible with a serial bus physical layer controller that complies with IEEE-Std-1394-1995, the serial bus interface circuitry interface including a plurality of output nodes including a transmit data node, transmit strobe node, a tri-stateable enable node and a open collector enable node.

23. The controller of claim 22 and further comprising:
register decode circuitry including a plurality of address bit inputs, the decode circuitry adapted to receive six-bit address data;
priority decode circuitry adapted to receive four-bit address data; and
logic internal to the controller, the logic causing the serial bus backplane physical layer controller to be reset.

24. The controller of claim 22 and further comprising internal logic that controls the tri-stateable output enable node such that when the controller is arbitrating for the bus, the controller drives a state that disables a transceiver that is connected to the transmit data node when the device is driving a logical zero on the bus and enables the transceiver when the device is driving a logical one on the bus.

25. The controller of 24 wherein the internal logic enables the tri-stateable output enable node for the entire duration of the transmission of a data packet subsequent to the winning of the arbitration for the bus.

26. A system comprising:
a serial bus, at least a first portion of the serial bus comprising conductive lines formed on a circuit board;
a physical layer controller coupled to the first portion of the serial bus, the physical layer controller comprising register decode circuitry including a plurality of address bit inputs and being adapted to receive six-bit address data, priority decode circuitry adapted to receive four-bit address data, and a means of resetting the serial bus backplane physical layer controller;
a link layer controller coupled to the physical layer controller; and
a processor coupled to the link layer controller .

27. The system of claim 26 wherein the physical layer controller is compatible with IEEE-Std-1394-1995.

28. The system of claim 26 wherein the processor comprises a digital signal processor.

29. The system of claim 26 wherein the bus resides within a standard parallel backplane.

30. The system of claim 29 wherein the standard parallel backplane is one of VME, Compact PCI, or FutureBus+.

31. The system of claim 26 wherein the bus system comprises the bus system of a wireless base station.
